(19) United States
(12) Patent Application Publication
(10) Pub. No.: US 2009/0320083 A1
(43) Pub. Date: Dec. 24, 2009

(54) Personal Media Viewer

(76) Inventor: Nabil Dajani, Orlando, FL (US)

Correspondence Address: HARSHAW RESEARCH, INC., 210 W. TECUMSEH STREET, OTTAWA, KS, 66067, US

(21) Appl. No.: 12/489,162

(22) Filed: Jun. 22, 2009

Related U.S. Application Data
(60) Provisional application No. 61/074,193, filed on Jun. 20, 2008.

(51) Int. Cl. H04N 7/173; G06F 3/041; H04N 5/91

(52) U.S. Cl. 725/110; 725/133; 345/173; 386/68

(57) ABSTRACT

A media viewer includes a housing having a monocular configuration having forward and rearward ends and defining an interior space. The forward end includes a lens through which a user may look into the interior space. A rear wall of the housing encloses the housing. A display is mounted upon an intermediate wall within the interior space and may be viewed by a user through the lens. An electronics area is defined between the intermediate and rear walls of the housing. A battery, central processing unit, and data storage devices are positioned within the electronics housing and are interconnect to one another and to the display. Interactive control buttons are positioned on an external surface of the housing such that programming from the data storage devices may be reviewed, selected, and viewed on the display. Content may be downloaded from subscriber websites onto the storage devices.

### REFERENCE RELATED APPLICATIONS

This application claims the priority of the U.S. Provisional Patent Application 61/074,193 filed on Jun. 20, 2008 entitled PERSONAL MEDIA VIEWER.

### BACKGROUND OF THE INVENTION

This invention relates generally to a video player and, more particularly, to a personal media viewer that enables a user to privately view different media formats through a fully enclosed scope. The media viewer enables a user to download preprogrammed training programs for selection and on-demand viewing.

Although not exclusive to players of the game of golf, amateur golfers are often faced with situations, especially during game play, in which reviewing how to make a particular type of shot would be of great benefit. For example, a player may desire to see a demonstration and hear instructive comments when finding his ball in a sand bunker and needing to make an appropriate shot. Further, a player may desire to see and hear instruction on how to slice or hook the ball before taking a tee shot on a hole having a dog leg configuration.

Various devices have been proposed in the prior art for displaying video in a handheld electronic device. Although assumably effective for their intended purposes, the existing devices do not provide a digital monocular device having multiple media storage devices in association with subscriber internet websites from which digital instructional content may be downloaded for on demand viewing using specialized and interactive button controls.

Therefore, it would be desirable to have a personal media viewer that enables a user to view digital media content previously stored or downloaded onto multiple forms of data storage. Further, it would be desirable to have a personal media viewer that has a fully enclosed scope with a single eye opening through which to view an LCD screen. In addition, it would be desirable to have a personal media viewer having user controls that enable a user to search through available content and select a desired instructional segment for interactive viewing.

### SUMMARY OF THE INVENTION

Accordingly, a media viewer according to a preferred embodiment of the present invention includes a housing having a monocular configuration, having forward and rearward ends, and defining an interior space. The forward end includes a lens through which a user may look into the interior space of the housing. A rear wall of the housing encloses the housing. A display is mounted upon an intermediate wall within the interior space and may be viewed by a user through the lens. An electronics area is defined between the intermediate and rear walls of the housing. A battery, central processing unit, and various data storage devices are positioned within the electronics area and are electrically connected to one another, the processor, and the display. Interactive control buttons are positioned on an external surface of the housing and are electrically connected to the processor such that content from the data storage devices may be reviewed, selected, and viewed on the display whenever desired by a user. Content may be downloaded from subscriber websites onto digital storage media for access and review using the personal media viewer.

Therefore, a general object of this invention is to provide a personal media viewer that may be associated with subscriber websites from which digital instructional content may be downloaded onto multiple selected media formats.

Another object of this invention is to provide a personal media viewer, as aforesaid, having specialized interactive viewing controls.

Yet another object of this invention is to provide a personal media viewer, as aforesaid, having a monocular configuration and housing for completely enclosing a viewing area.

A further object of this invention is to provide a personal media viewer, as aforesaid, that is easy to use and economical to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a personal media viewer according to a preferred embodiment of the present invention;

FIG. 2 is an exploded view of the media viewer as in FIG. 1;

FIG. 3a is a top view of the media viewer as in FIG. 1;

FIG. 3b is a sectional view taken along line 3b-3b of FIG. 3a;

FIG. 4 is a block diagram of a personal media viewer in use with the internet and a personal computer;

FIG. 5 is a block diagram of the electronic components of the media viewer; and

FIG. 6 is a flowchart illustrating the logic performed by the processor of the media viewer according to the present invention.

### DESCRIPTION OF THE PREFERRED EMBODIMENT

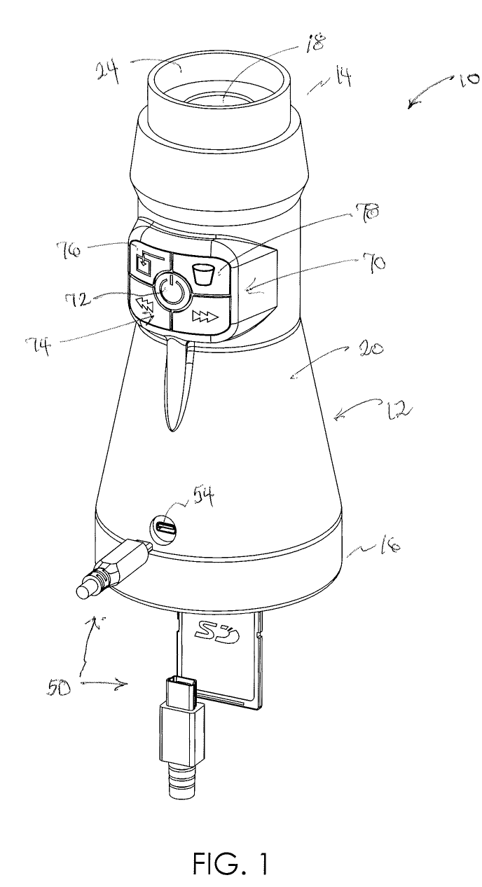

A personal media viewer 10 according to the present invention will now be described in detail with reference to FIGS. 1 to 6 of the accompanying drawings. More particularly, the personal media viewer 10 includes a portable housing 12 having opposed front 14 and rear 16 ends (FIG. 1). The housing 12 includes a generally cylindrical monocular shaped configuration with the front end 14 having a diameter smaller than the rear end 16. A continuous side wall 20 extends between front 14 and rear 16 ends and includes a rear end wall 22. Therefore, the housing 12 is completely enclosed except that the front end 14 includes a transparent lens 18 through which a person may look into the housing 12 using one eye. The front end 14 may include a rubber or foam cushion member 24 such that a user may comfortably hold the front end 14 up to his eye in use. The housing walls define an interior space within the housing 12.

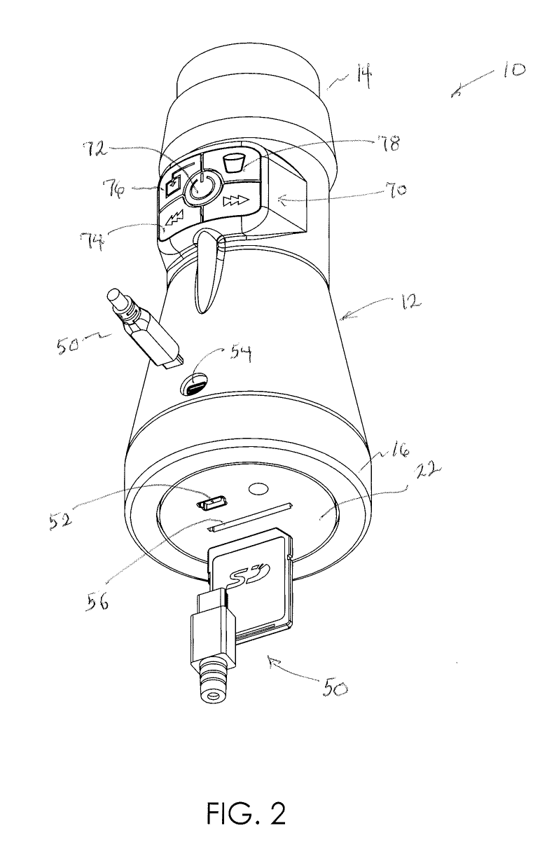

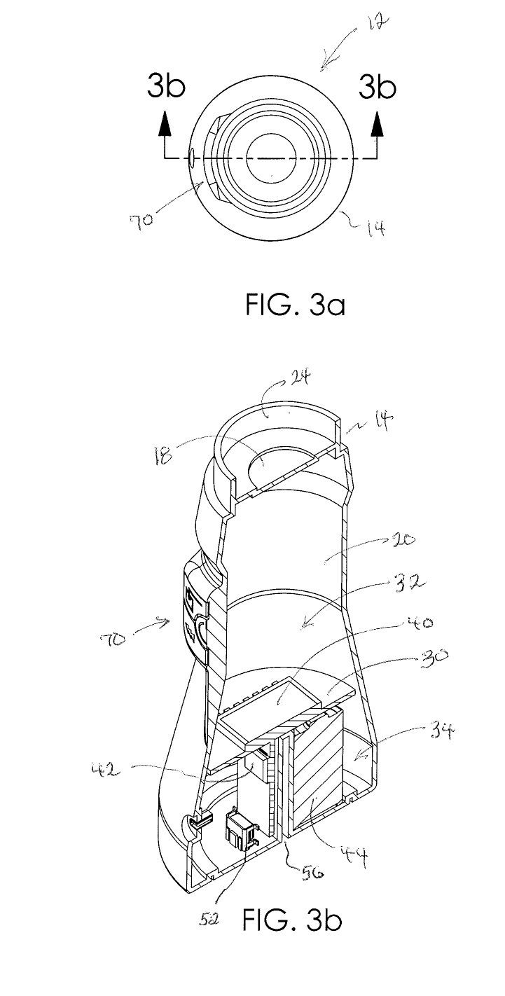

The housing 12 may include an intermediate wall 30 positioned within the interior space of the housing 12 that separates the interior space into a viewing area 32 and an electronics area 34 (FIG. 2). A display 40, such as a LCD screen, is mounted to a front side of the intermediate wall 30 and positioned so that it may be viewed by a user looking through the front end 14 of the housing 12 (FIG. 3b). A central processing unit 42 (“CPU”) and a battery 44 are positioned in the electronics area 34 and are electrically connected. The CPU 42 is in data communication with the display 40.

Digital content stored on multiple types of media storage devices 50 may be connected to the viewer 10 and content may be read and processed by the CPU 42 and selectively displayed on the display 40. More particularly, the personal media viewer 10 may include a mini-USB port 52, a micro-USB port 54, a memory card slot 56. It is understood that these storage media may be connected to a personal computer having internet access from which content may be downloaded for use with the viewer 10, as will be further described below. Other storage devices such as compact disc, DVD, or the like would also be possible.

The personal media viewer 10 may be associated with one or more subscriber websites 60 from which content may be downloaded to one of the media storage devices described above. More particularly, one or more websites 60 may be created, each website including one or more of video footage, slides, text, audio, computer generated graphics, or the like. Each video may be segmented so that it may be advanced frame by frame or in segmented clips when viewed by the personal media viewer 10 as will be described later. Further, each website may include a password layer such that it may only be accessed by authorized persons. In other words, these websites may be restricted to paying subscribers.

The personal media viewer 10 includes user controls 70, also referred to herein as an input device, positioned on the housing 12 such that content may be selected and viewed in selected formats or playback modes. The user controls 70 may include an on/off button 72, navigation buttons 74 for selecting a desired segment, a select button 76 for activating the segment, a delete button 78 for removing content, or other buttons (not shown) for controlling playback. The central processor 42 of the personal media viewer 10 includes programming for enabling a user to access a memory 46 or one or more media storage devices 50 and to select content for viewing upon the display 40. It is understood that the input device may be a touch screen display positioned on the outside walls of the housing by which user controls may be selected and controlled.

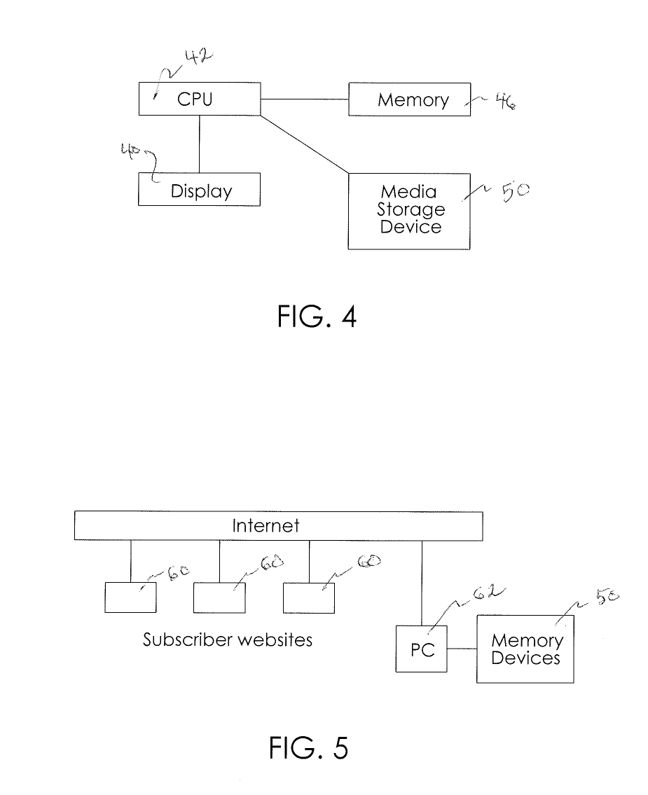

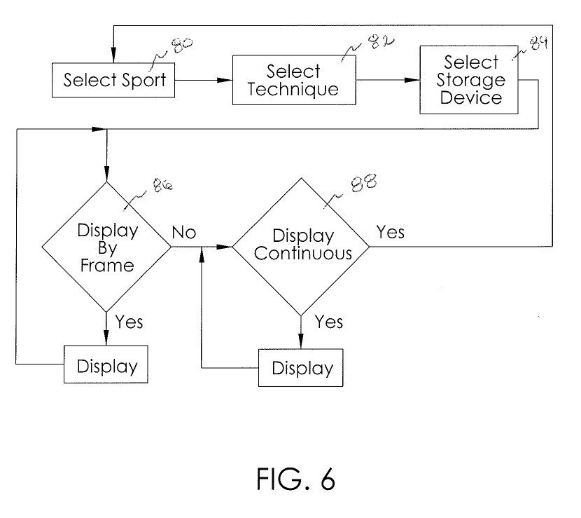

In use, a user may use a personal computer 62 connected to the Internet to login to a website 60 to which he is a registered user, search through the content provided by the website 60, and download respective content to one of the many media storage devices 50 (FIG. 4). It is understood that the downloadable content may include video clips of a sports technique, computer generated animations, text or audio overlays to the video or graphics, and the like. Then, when using the personal media viewer 10, for example, while on the golf course, a user may watch a selected video segment so as to perform a needed shot with greater confidence and success. As more particularly shown in FIG. 6, a user may manipulate the user controls to select a sport 80 and select a specific technique 82 or shot to view. The CPU 42 may be programmed to automatically search all available data devices or the user may select the appropriate storage device to speed up the selection process, as indicated at 84. Then, a user may select whether to display the selected content frame by frame 86 or continuously 88.

It is understood that while certain forms of this invention have been illustrated and described, it is not limited thereto except insofar as such limitations are included in the following claims and allowable functional equivalents thereof.

1. A personal media viewer, comprising:
a housing having opposed front and rear ends and a continuous side wall extending therebetween, said housing having a generally cylindrical configuration defining an interior space;
wherein said front end is open and said rear end is closed;
a transparent lens positioned at said housing front end through which a user may look into said interior space using one eye;
a processor positioned in said interior space;
a display positioned in said interior space that is in data communication with said processor;
means for interfacing said processor with at least one digital storage device so said at least one digital storage device is in data communication with said processor and said display; and
programming in said processor for reading data from a respective interfaced digital storage device and directing said read data to be displayed by said display.

2. The personal media viewer as in claim 1, wherein said housing front end includes a diameter that is smaller than a diameter of said housing rear end.

3. The personal media viewer as in claim 2, wherein said housing includes a monocular configuration.

4. The personal media viewer as in claim 1, wherein said housing includes an intermediate wall in said interior space situated between said front and rear ends that divides said interior space into a viewing area adjacent said front end and an electronics area adjacent said rear end, said display being positioned in said viewing area and said processor being positioned in said electronics area.

5. The personal media viewer as in claim 1, further comprising an input device positioned on an outer surface of said housing and in data communication with said processor for use by a user.

6. The personal media viewer as in claim 5, wherein said input device includes at least one user control button taken from the group including a navigation button, a selection button, and a deletion button.

7. The personal media viewer as in claim 6, wherein said input device is a touch screen.

8. The personal media viewer as in claim 1, wherein said interfacing means includes a mini-USB port.

9. The personal media viewer as in claim 1, wherein said interfacing means includes a micro-USB port.

10. The personal media viewer as in claim 1, wherein said interfacing means includes a memory card slot.

11. The personal media viewer as in claim 1, further comprising at least one associated network website operated remote from and unconnected to said housing, said website having digital content that may be downloaded to said digital storage device and read by said processor when said digital storage device is interfaced with said processor.

12. The personal media viewer as in claim 11, wherein said at least one associated website includes means for controlling user access thereto.

13. The personal media viewer as in claim 6, further comprising programming in said processor for manipulating respective data read from a respective digital storage device according to data from said input device.

14. The personal media viewer as in claim 13, wherein said programming for manipulating data includes directing said data to be displayed one frame at a time.

15. The personal media viewer as in claim 13, wherein said programming for manipulating data includes directing said data to be displayed continuously.

16. A personal media viewing system, comprising:
a housing having opposed front and rear ends and a continuous side wall extending therebetween, said housing having a generally cylindrical configuration defining an interior space;
wherein said front end is open and said rear end is closed;
a transparent lens positioned at said housing front end through which a user may look into said interior space using one eye; a processor positioned in said interior space;
a display positioned in said interior space that is in data communication with said processor;
means for interfacing said processor with at least one digital storage device so said at least one digital storage device is in data communication with said processor and said display;
programming in said processor for reading data from a respective interfaced digital storage device and directing said read data to be displayed by said display; and
at least one associated subscriber network website operated remote from and unconnected to said housing, said website having digital content that may be downloaded to said digital storage device and read by said processor when said digital storage device is interfaced with said processor.

17. The personal media viewer as in claim 16, wherein said housing includes a monocular configuration in which said front end includes a diameter that is smaller than a diameter of said housing rear end.

18. The personal media viewer as in claim 16, further comprising:
processing in said processor for selectively manipulating respective digital media read from a respective digital storage device according to data from said input device;
processing in said processor for selectively directing respective data from said respective digital storage device to be displayed one frame at a time; and
processing in said processor for selectively directing respective data from said respective digital storage device to be displayed as a continuous stream.

19. The personal media viewer as in claim 16, wherein said housing includes an intermediate wall in said interior space situated between said front and rear ends that divides said interior space into a viewing area adjacent said front end and an electronics area adjacent said rear end, said display being positioned in said viewing area and said processor being positioned in said electronics area.

20. The personal media viewer as in claim 16, wherein said interfacing means includes a mini-USB port, a micro-USB port, and a memory card slot.

21. The personal media viewer as in claim 16, further comprising an input device positioned on an outer surface of said housing and in data communication with said processor for use by a user.

22. The personal media viewer as in claim 21, wherein said input device includes at least one user control button taken from the group including a navigation button, a selection button, and a deletion button.
